(19) United States
(12) Patent Application Publication
(10) Pub. No.: US 2026/0085595 A1
(43) Pub. Date: Mar. 26, 2026

(54) MONITORING DEVICE, MONITORING METHOD, AND NON-TRANSITORY COMPUTER READABLE MEDIUM

(71) Applicant: NEC Corporation, Tokyo (JP)

(72) Inventor: Masato YOSHIOKA, Tokyo (JP)

(73) Assignee: NEC Corporation, Tokyo (JP)

(21) Appl. No.: 19/325,707

(22) Filed: Sep. 11, 2025

(30) Foreign Application Priority Data
Sep. 25, 2024 (JP) 2024-165768

(51) Int. Cl. E21B 41/00; G01H 9/00; G01V 1/38

(52) U.S. Cl. CPC E21B 41/0064; G01H 9/004; G01V 1/3808

(57) ABSTRACT

A monitoring device includes at least one memory that stores instructions, and at least one processor configured to execute the instructions to receive backscattered light from an optical fiber laid around a gas reservoir provided in a ground, identify a temporal change in vibration generated in the optical fiber based on the backscattered light, and identify a state of the gas reservoir based on the temporal change in the vibration, and control a gas injection amount into the gas reservoir based on the state of the gas reservoir.

### INCORPORATION BY REFERENCE

This application is based upon and claims the benefit of priority from Japanese patent application No. 2024-165768, filed on Sep. 25, 2024, the disclosure of which is incorporated herein in its entirety by reference.

### TECHNICAL FIELD

The present disclosure relates to a monitoring device, a monitoring method, and a non-transitory computer readable medium.

### BACKGROUND ART

In recent years, carbon dioxide capture and storage (CCS), which is a technique for recovering carbon dioxide generated in power plants, chemical plants, and the like, and injecting and storing the recovered carbon dioxide into the ground, has attracted attention.

By storing carbon dioxide in the ground by CCS, it is expected to reduce the emission amount of carbon dioxide into the atmosphere. On the other hand, in order to confirm whether carbon dioxide is stably stored in the ground, it is necessary to monitor a state of a gas reservoir that stores carbon dioxide.

However, in a case where a gas reservoir for storing carbon dioxide is provided in the ground of a sea floor, equipment used for monitoring the gas reservoir on land cannot be installed. Therefore, in a case where a gas reservoir is provided in the ground of the sea floor, the state of the gas reservoir is mainly monitored using a three-dimensional physical exploration vessel or an ocean bottom cable (OBC).

However, monitoring using the three-dimensional physical exploration vessel or the OBC is highly accurate, but is expensive, and thus has economic constraints. Therefore, in a case where the three-dimensional physical exploration vessel or the OBC is used, it is not possible to frequently monitor the state of the gas reservoir.

On the other hand, in recent years, a monitoring technique called optical fiber sensing represented by distributed acoustic sensing (DAS) has attracted attention. Since the optical fiber sensing uses an optical fiber laid on the sea floor or the like as a sensor, it is possible to perform monitoring at low cost as compared with the case of using a three-dimensional physical exploration vessel or an OBC.

Therefore, recently, it has been proposed to monitor the state of a gas reservoir using optical fiber sensing in a case where the gas reservoir for storing gas such as carbon dioxide is provided in the ground.

For example, according to Patent Literature 1, an optical fiber is laid on the sea floor above a reservoir of petroleum and natural gas provided in the ground of the sea floor. In a case where an acoustic wave is generated from the sea, the acoustic wave propagates in the sea, propagates from the sea floor to the reservoir, and is reflected by a stratum. The reflected acoustic wave reaches the optical fiber to measure the acoustic wave generated in the optical fiber. At this time, since a reflection state of the acoustic wave changes depending on a storage state of petroleum and natural gas in the reservoir, it is possible to grasp the storage state of petroleum and natural gas in the reservoir.
[Patent Literature 1] International Patent Publication No. WO 2016/021689

### SUMMARY

According to the technique disclosed in Patent Literature 1, it is considered that the state of a gas reservoir provided in the ground can be monitored using optical fiber sensing. However, in the technique disclosed in Patent Literature 1, it is not possible to perform management such as injecting the gas into the gas reservoir to the maximum extent in such a way that the gas does not leak from the gas reservoir. Therefore, a technique capable of appropriately managing a gas reservoir provided in the ground is desired.

Therefore, in view of the above-described problems, an object of the present disclosure is to provide a monitoring device, a monitoring method, and a non-transitory computer readable medium capable of appropriately managing a gas reservoir provided in the ground.

A monitoring device according to a first example aspect includes
at least one memory that stores instructions, and
at least one processor configured to
   execute the instructions to receive backscattered light from an optical fiber laid around a gas reservoir provided in a ground,
   identify a temporal change in vibration generated in the optical fiber based on the backscattered light, and identify a state of the gas reservoir based on the temporal change in the vibration, and
   control a gas injection amount into the gas reservoir based on the state of the gas reservoir.

A monitoring method according to a second example aspect executed by a monitoring device, includes
receiving backscattered light from an optical fiber laid around a gas reservoir provided in a ground,
identifying a temporal change in vibration generated in the optical fiber based on the backscattered light, and identifying a state of the gas reservoir based on the temporal change in the vibration, and
controlling the gas injection amount into the gas reservoir based on the state of the gas reservoir.

A non-transitory computer readable medium storing a program according to a third example aspect causes a computer to execute
receiving backscattered light from an optical fiber laid around a gas reservoir provided in a ground,
identifying a temporal change in vibration generated in the optical fiber based on the backscattered light and identifying a state of the gas reservoir based on the temporal change in the vibration, and
controlling the gas injection amount into the gas reservoir based on the state of the gas reservoir.

According to the above-described aspect, it is possible to provide a monitoring device, a monitoring method, and a non-transitory computer readable medium capable of appropriately managing a gas reservoir provided in the ground.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram illustrating an installation example of a monitoring device according to the present disclosure;

FIG. 2 is a block diagram illustrating a configuration example of the monitoring device according to the present disclosure;

FIG. 3 is a flowchart illustrating an example of an operation flow of the monitoring device according to the present disclosure;

FIG. 4 is a block diagram illustrating a configuration example of a monitoring device according to the present disclosure;

FIG. 5 is a diagram illustrating an operation example of an imaging unit according to the present disclosure;

FIG. 6 is a flowchart illustrating an example of an operation flow of the monitoring device according to the present disclosure;

FIG. 7 is a block diagram illustrating a configuration example of a monitoring device according to the present disclosure; and

FIG. 8 is a block diagram illustrating a hardware configuration example of a computer that implements the monitoring device according to the present disclosure.

### EXAMPLE EMBODIMENTS

Example embodiments of the present disclosure will be described below with reference to the drawings. The following description and drawings are omitted and simplified as appropriate for clarity of description. In the following drawings, the same elements will be denoted by the same reference signs, and redundant description will be omitted as necessary.

### First Example Embodiment

First, an installation example of a monitoring device 10 according to the present disclosure will be described.

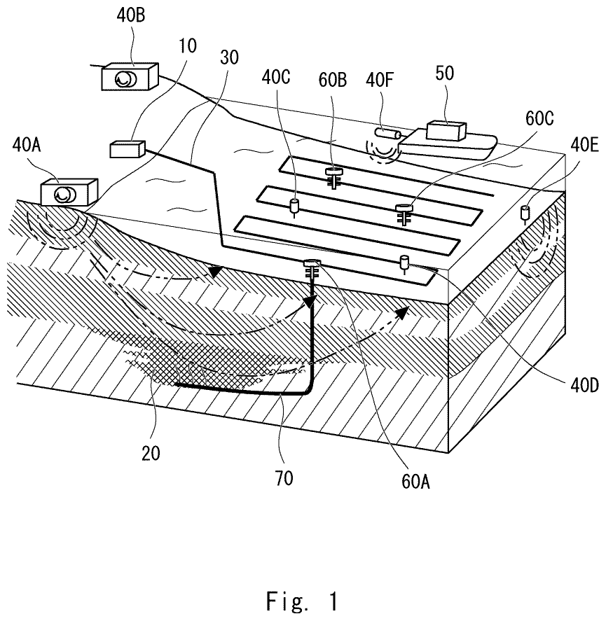

FIG. 1 is a diagram illustrating an installation example of the monitoring device 10 according to the present disclosure.

In the example of FIG. 1, carbon dioxide is stored in a gas reservoir 20 provided in the ground by CCS. For this purpose, injection wells 60A to 60C and an injection cable 70 are provided.

The injection wells 60A to 60C are provided on the ground, and the injection well 60A is connected to the gas reservoir 20 via the injection cable 70. Although not illustrated, the injection wells 60B and 60C are also connected to the gas reservoir 20 via the injection cable 70. The carbon dioxide is injected and stored in the gas reservoir 20 from the injection wells 60A to 60C via the injection cable 70.

In the example of FIG. 1, the state of the gas reservoir 20 is monitored by optical fiber sensing using an optical fiber 30. Therefore, the monitoring device 10, the optical fiber 30, and seismic wave generation sources 40A to 40F are provided.

The optical fiber 30 is laid around the gas reservoir 20. In the example of FIG. 1, the optical fiber 30 is laid on the sea floor around the gas reservoir 20, but may be buried in the ground of the sea floor around the gas reservoir 20.

The seismic wave generation sources 40A to 40F generate seismic waves. Among them, the seismic wave generation sources 40A and 40B are provided on the ground, and the seismic wave generation sources 40C to 40E are provided on the sea floor. The seismic wave generation source 40F is mounted on a vessel 50 such as an autonomous surface vessel (ASV).

The monitoring device 10 is provided on the ground and connected to the optical fiber 30. For example, the monitoring device 10 is achieved by a DAS device or the like.

The monitoring device 10 schematically operates as follows.

In a case where seismic waves are generated by any one of the seismic wave generation sources 40A to 40F, the seismic waves are transmitted to the ground of the sea floor, reflected by a stratum, transmitted to the optical fiber 30, and vibration is generated in the optical fiber 30. The monitoring device 10 identifies a temporal change in the vibration generated in the optical fiber 30 based on a backscattered light received from the optical fiber 30, and identifies the state of the gas reservoir 20 based on the temporal change in the vibration. The monitoring device 10 controls the amount of carbon dioxide to be injected from the injection wells 60A to 60C into the gas reservoir 20 based on the state of the gas reservoir 20.

Next, a configuration example of the monitoring device 10 according to the present disclosure will be described.

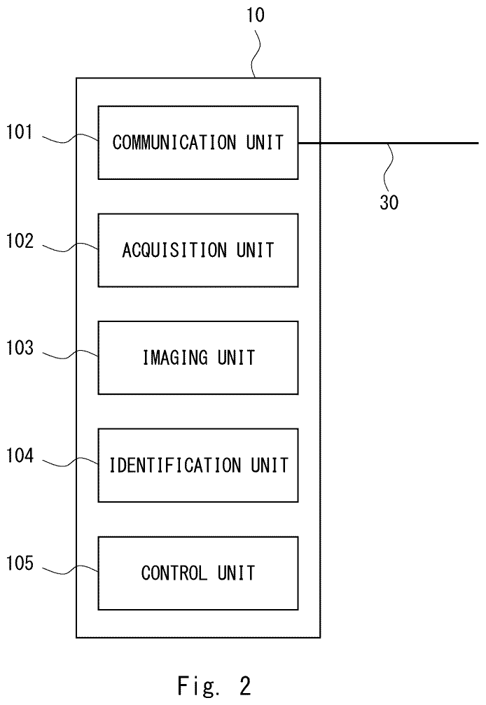

FIG. 2 is a block diagram illustrating a configuration example of the monitoring device 10 according to the present disclosure.

As illustrated in FIG. 2, the monitoring device 10 includes a communication unit 101, an acquisition unit 102, an imaging unit 103, an identification unit 104, and a control unit 105. The acquisition unit 102, the imaging unit 103, the identification unit 104, and the control unit may be provided in a separate device different from the monitoring device 10, or may be provided on a cloud.

The optical fiber 30 is connected to the communication unit 101.

The communication unit 101 transmits pulsed light to the optical fiber 30. The communication unit 101 receives, from the optical fiber 30, backscattered light generated as pulsed light is transmitted through the optical fiber 30.

The acquisition unit 102 can identify a position where the backscattered light is generated (a distance of the optical fiber 30 from the communication unit 101) based on a time difference between a time at which the pulsed light is transmitted to the optical fiber 30 by the communication unit 101 and a time at which the backscattered light is received from the optical fiber 30 by the communication unit 101. The acquisition unit 102 can detect vibration generated in the optical fiber 30 between two points by detecting a phase difference of the backscattered light generated at the two points on the optical fiber 30.

Therefore, the acquisition unit 102 acquires, for each distance of the optical fiber 30 from the communication unit 101, vibration reception data indicating a temporal change in vibration generated at the distance based on backscattered light generated at the distance.

The imaging unit 103 generates an image by imaging the vibration reception data acquired by the acquisition unit 102. Hereinafter, the image generated by the imaging unit 103 is referred to as an optical fiber physical exploration image. For example, in the optical fiber physical exploration image, the horizontal axis represents the distance of the optical fiber 30 from the communication unit 101, and the vertical axis represents the temporal change in the vibration generated at each distance.

The identification unit 104 identifies the state of the gas reservoir 20 based on the optical fiber physical exploration image generated by the imaging unit 103. Specifically, the identification unit 104 identifies the density of carbon dioxide in the gas reservoir 20 as the state of the gas reservoir 20.

Here, in the optical fiber physical exploration image, a unique vibration pattern in which the intensity of vibration, the vibration position, the transition of the fluctuation of the frequency, and the like are different depending on the density of carbon dioxide in the gas reservoir 20 appears. Therefore, the identification unit 104 identifies the density of carbon dioxide in the gas reservoir 20 based on the vibration pattern appearing in the optical fiber physical exploration image.

For example, the identification unit 104 may hold a learning model in which a correspondence between the density of carbon dioxide in the gas reservoir 20 and the vibration pattern appearing in the optical fiber physical exploration image at the density is learned in advance. For example, this learning model is a learning model that outputs the density of carbon dioxide in the gas reservoir 20 at that time by inputting a vibration pattern appearing in the optical fiber physical exploration image. For example, in learning of this learning model, the identification unit 104 may adjust parameters of the learning model in such a way that a difference between the output of the learning model at the time of inputting the vibration pattern appearing in the optical fiber physical exploration image to the learning model and the density of carbon dioxide in the gas reservoir 20 at that time approaches 0. Then, the identification unit 104 may input the optical fiber physical exploration image generated by the imaging unit 103 to the learning model and obtain the density of carbon dioxide in the gas reservoir 20 as an output of the learning model. This learning model may be a learning model by a convolutional neural network (CNN) or the like.

The control unit 105 controls the amount of carbon dioxide to be injected from the injection wells 60A to 60C into the gas reservoir 20 based on the state of the gas reservoir 20 identified by the identification unit 104. For example, the control unit 105 controls the amount of carbon dioxide to be injected into the gas reservoir 20 to the maximum in such a way that carbon dioxide does not leak from the gas reservoir 20.

Next, an example of an operation flow of the monitoring device 10 according to the present disclosure will be described.

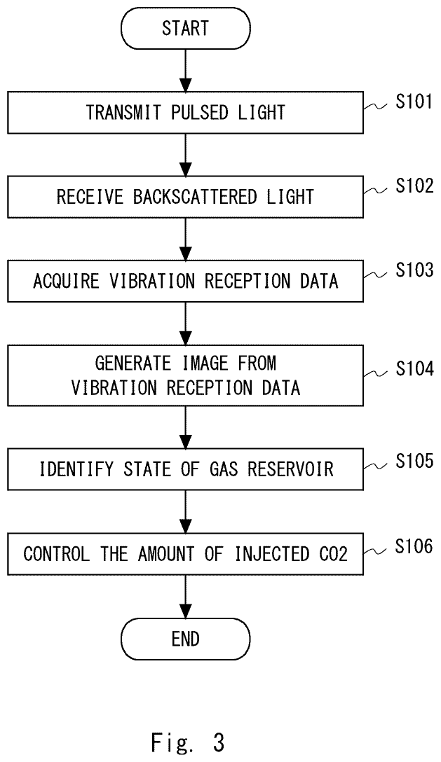

FIG. 3 is a flowchart illustrating an example of a flow of operation of the monitoring device 10 according to the present disclosure.

As illustrated in FIG. 3, first, the communication unit 101 transmits pulsed light to the optical fiber 30 (step S101), and receives backscattered light generated as the pulsed light is transmitted through the optical fiber 30 from the optical fiber 30 (step S102).

Therefore, the acquisition unit 102 acquires, for each distance of the optical fiber 30 from the communication unit 101, vibration reception data indicating a temporal change in vibration generated at the distance based on backscattered light generated at the distance (step S103).

Next, the imaging unit 103 generates an optical fiber physical exploration image by imaging the vibration reception data acquired by the acquisition unit 102 (step S104).

Next, the identification unit 104 identifies the state of the gas reservoir 20 based on the optical fiber physical exploration image generated by the imaging unit 103 (step S105).

Thereafter, the control unit 105 controls the amount of carbon dioxide to be injected from the injection wells 60A to 60C into the gas reservoir 20 based on the state of the gas reservoir 20 identified by the identification unit 104 (step S106).

As described above, according to a first example embodiment, the communication unit 101 transmits pulsed light to the optical fiber 30 and receives backscattered light from the optical fiber 30. The acquisition unit 102 acquires vibration reception data indicating a temporal change in vibration generated in the optical fiber 30 based on the backscattered light. The imaging unit 103 generates an optical fiber physical exploration image by imaging the vibration reception data. The identification unit 104 identifies the state of the gas reservoir 20 based on the optical fiber physical exploration image. The control unit 105 controls the amount of carbon dioxide to be injected into the gas reservoir 20 based on the state of the gas reservoir 20.

As described above, according to the first example embodiment, since it is possible to control the amount of carbon dioxide to be injected into the gas reservoir 20 based on the state of the gas reservoir 20, it is possible to appropriately manage the gas reservoir 20 by injecting carbon dioxide into the gas reservoir 20 to the maximum in such a way as not to leak carbon dioxide from the gas reservoir 20.

According to the first example embodiment, since the state of the gas reservoir 20 is monitored by optical fiber sensing using the optical fiber 30, the state of the gas reservoir 20 can be monitored at low cost and with high frequency. This makes it possible to shorten a time space for monitoring the state of the gas reservoir 20, and thus it is possible to adjust the amount of carbon dioxide to be injected before carbon dioxide in the ground is unexpectedly diffused and reaches a crack such as a fault. As a result, it is possible to more appropriately manage the gas reservoir 20.

### Second Example Embodiment

First, a configuration example of a monitoring device 10A according to the present disclosure will be described.

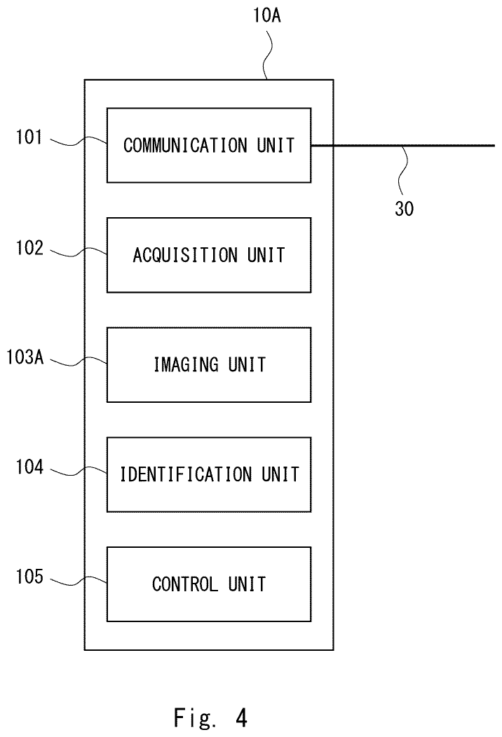

FIG. 4 is a block diagram illustrating a configuration example of the monitoring device 10A according to the present disclosure.

As illustrated in FIG. 4, the monitoring device 10A is different from the monitoring device 10 described above in that the imaging unit 103 is replaced with an imaging unit 103A.

Similarly to the imaging unit 103, the imaging unit 103A generates an optical fiber physical exploration image by imaging the vibration reception data acquired by the acquisition unit 102.

Here, the vibration reception data is data acquired based on the backscattered light received from the optical fiber 30, that is, data acquired by optical fiber sensing. Therefore, the optical fiber physical exploration image generated based on the vibration reception data generally contains many noise components and has low resolution. Therefore, since the identification unit 104 identifies the state of the gas reservoir 20 based on the optical fiber physical exploration image having low resolution, there is a concern that the identification accuracy deteriorates.

On the other hand, also in the method of monitoring the state of the gas reservoir 20 using the three-dimensional physical exploration vessel or the OBC, in the monitoring processing, similarly to the optical fiber physical exploration image, an image in which the temporal change in the vibration generated due to a seismic wave reflected by a stratum is imaged is generated. However, since the image generated using the three-dimensional physical exploration vessel or the OBC has a small noise component and a high resolution, it is possible to identify the state of the gas reservoir 20 with high accuracy.

Therefore, the imaging unit 103A generates the optical fiber physical exploration image in which the noise component is suppressed by learning in advance the noise component included in the optical fiber physical exploration image using the image generated using the three-dimensional physical exploration vessel or the OBC. As a result, the identification unit 104 can identify the state of the gas reservoir 20 based on the optical fiber physical exploration image having high resolution after the noise component is suppressed, in such a way that the identification accuracy can be improved.

Here, an operation example of the imaging unit 103a according to the present disclosure will be described.

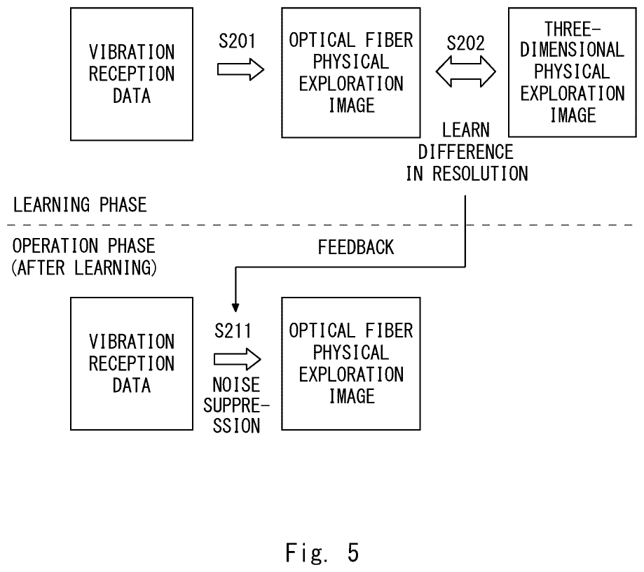

FIG. 5 is a diagram illustrating an operation example of the imaging unit 103A according to the present disclosure. In the example of FIG. 5, it is assumed that the imaging unit 103A uses an image (hereinafter, referred to as a three-dimensional physical exploration image) generated using the three-dimensional physical exploration vessel. The vertical axis and the horizontal axis of the three-dimensional physical exploration image are similar to those of the optical fiber physical exploration image.

As illustrated in FIG. 5, in the learning phase, a three-dimensional physical exploration image obtained by imaging a temporal change in vibration generated in a specific area due to a seismic wave reflected by a stratum is acquired in advance. The imaging unit 103A generates an optical fiber physical exploration image by imaging the vibration reception data acquired based on the backscattered light generated in a specific area among the backscattered light received from the optical fiber 30 (step S201). Next, the imaging unit 103A obtains a difference in resolution between the optical fiber physical exploration image generated in step S201 and the three-dimensional physical exploration image acquired in advance. This difference in resolution is associated with a noise component included in the optical fiber physical exploration image. Therefore, the imaging unit 103A learns the features of the resolution difference (noise component) (step S202). This learning is performed using a plurality of optical fiber physical exploration images and three-dimensional physical exploration images.

In an operation phase, the imaging unit 103A feeds back the features of the difference in resolution (noise component) learned in the learning phase, and generates the optical fiber physical exploration image in which the noise component is suppressed (step S211).

For example, the imaging unit 103A may hold a learning model in which the feature of the difference in resolution (noise component) between the optical fiber physical exploration image and the three-dimensional physical exploration image has been learned in advance in the learning phase. For example, this learning model is a learning model that outputs an optical fiber physical exploration image in which a noise component is suppressed from the optical fiber physical exploration image by inputting the optical fiber physical exploration image obtained by imaging the vibration reception data. For example, in the learning phase, the imaging unit 103A may adjust the parameters of the learning model in such a way that a difference between the output of the learning model in a case where the optical fiber physical exploration image obtained by imaging the vibration reception data is input to the learning model and the three-dimensional physical exploration image approaches 0. Then, in the operation phase, the imaging unit 103A may input the optical fiber physical exploration image obtained by imaging the vibration reception data to the learning model and obtain the optical fiber physical exploration image in which the noise component is suppressed as an output of the learning model. This learning model may be a learning model by a convolutional neural network (CNN) or the like.

The vibration generated due to the seismic waves reflected by the stratum is attenuated, in such a way that a trajectory of the vibration may be unclear on the optical fiber physical exploration image. Therefore, in addition to the processing of suppressing noise, the imaging unit 103A may additionally perform processing of clarifying the trajectory of vibration generated due to the seismic wave reflected by the stratum on the optical fiber physical exploration image. The processing added here is, for example, the following processing. The imaging unit 103A extracts the trajectory of the vibration described above for the optical fiber physical exploration image, and after a part of the trajectory is extracted, the imaging unit 103A normalizes the optical fiber physical exploration image after masking the part of the extracted trajectory. Then, the imaging unit 103A performs the extraction, masking, and normalization described above on the normalized optical fiber physical exploration image. Thereafter, the imaging unit 103A repeats the extraction, masking, and normalization described above. The imaging unit 103A may hold a learning model that has learned the trajectory of vibration described above, and extract the trajectory of vibration described above using this learning model.

Next, an example of an operation flow of the monitoring device 10A according to the present disclosure will be described.

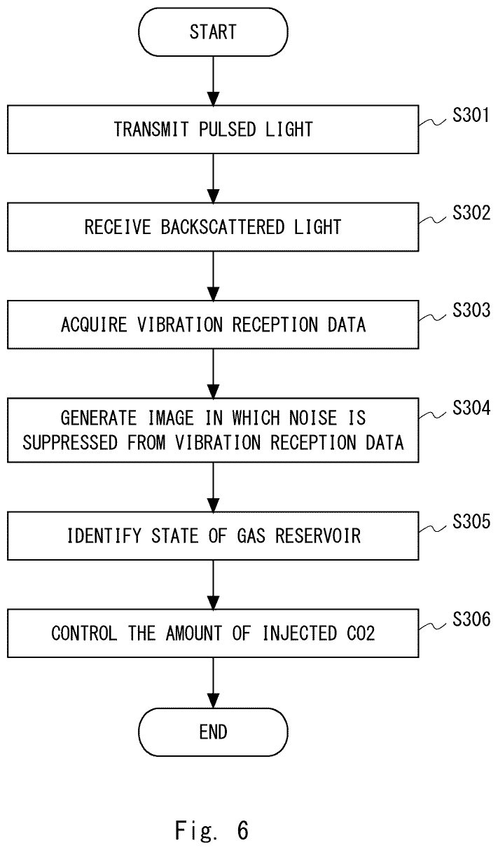

FIG. 6 is a flowchart illustrating an example of an operation flow of the monitoring device 10A according to the present disclosure. FIG. 6 illustrates an example of the operation in the operation phase, and it is assumed that the imaging unit 103A has learned the feature of a difference in resolution (noise component) in the learning phase performed in advance.

As illustrated in FIG. 6, first, the processing of steps S301 to S303 similar to steps S101 to S103 of FIG. 3 is performed.

Next, the imaging unit 103A feeds back the feature of the difference in resolution (noise component) learned in the learning phase, and generates an optical fiber physical exploration image in which the noise component is suppressed from the optical fiber physical exploration image obtained by imaging the vibration reception data based on the feature of the difference in resolution (noise component) (step S304).

Thereafter, processing in steps S305 and S306 similar to steps S105 and S106 in FIG. 3 is performed.

As described above, according to the second example embodiment, in the learning phase, the imaging unit 103A learns the feature of the difference in resolution (noise component) between the optical fiber physical exploration image and the image generated using the three-dimensional physical exploration vessel or the OBC, and in the operation phase, feeds back the feature of the difference in resolution (noise component) learned to generate the optical fiber physical exploration image in which the noise component is suppressed.

As described above, according to the second example embodiment, the identification unit 104 can identify the state of the gas reservoir 20 based on the optical fiber physical exploration image having high resolution after the noise component is suppressed, in such a way that the identification accuracy can be improved.

The other effects are similar to the effects according to the first example embodiment described above.

### Third Example Embodiment

A third example embodiment is associated with an example embodiment that generalizes the first and second example embodiments described above.

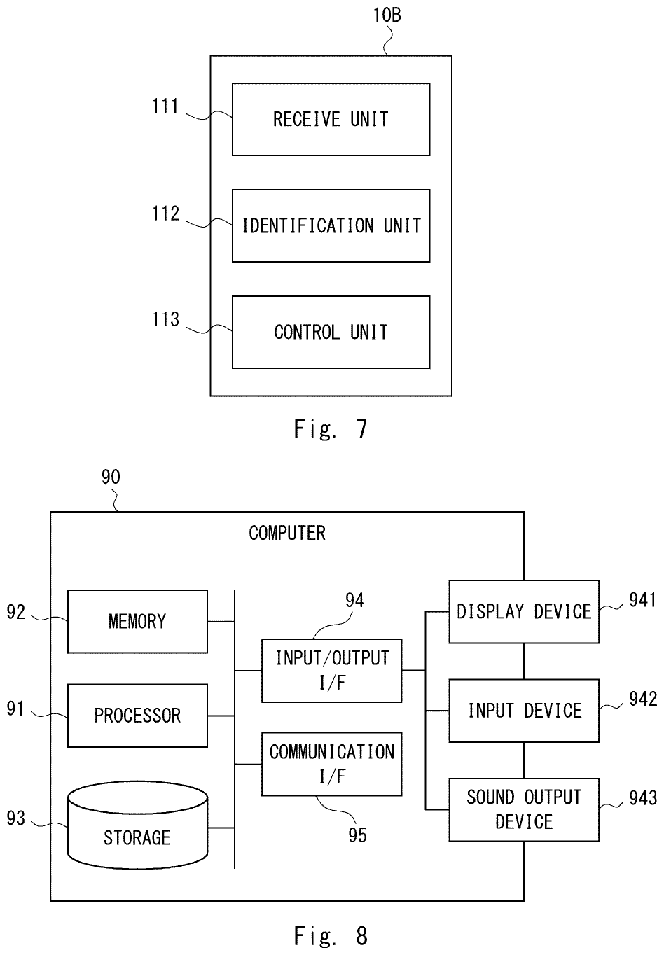

FIG. 7 is a block diagram illustrating a configuration example of a monitoring device 10B according to the present disclosure.

As illustrated in FIG. 7, the monitoring device 10B includes a reception unit 111, an identification unit 112, and a control unit 113.

The reception unit 111 receives backscattered light from an optical fiber laid around a gas reservoir provided in the ground.

The identification unit 112 identifies a temporal change in the vibration generated in the optical fiber based on the backscattered light, and identifies the state of the gas reservoir based on the temporal change in the vibration.

The control unit 113 controls the gas injection amount into the gas reservoir based on the state of the gas reservoir.

As described above, according to the third example embodiment, since it is possible to control the amount of gas to be injected into the gas reservoir based on the state of the gas reservoir, it is possible to appropriately manage the gas reservoir.

The identification unit 112 may identify the state of the gas reservoir based on a temporal change in vibration generated in the optical fiber by transmitting the seismic wave generated in the seismic wave generation source and reflected by the stratum to the optical fiber.

The identification unit 112 may learn in advance the features of the noise component included in the first image obtained by imaging the temporal change in the vibration identified based on the backscattered light, suppress the noise component from the first image based on the learning result, and identify the state of the gas reservoir based on the image after the noise component is suppressed from the first image.

The identification unit 112 may learn the features of the noise component included in the first image based on a difference in resolution between the first image and the second image obtained by imaging the temporal change in the vibration identified using a predetermined method. The predetermined method may be a method using a three-dimensional physical exploration vessel or an Ocean Bottom Cable (OBC).

The gas reservoir may be a reservoir for storing carbon dioxide.

### Hardware Configuration of Monitoring Device

FIG. 8 is a block diagram illustrating a schematic hardware configuration example of a computer 90 that implements the monitoring devices 10,10A, and 10B according to the present disclosure.

As illustrated in FIG. 8, the computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected by a data transmission path for mutually transmitting and receiving data.

The processor 91 is, for example, an arithmetic processing device such as a central processing unit (CPU) or a graphics processing unit (GPU). The memory 92 is, for example, a memory such as a random access memory (RAM) or a read only memory (ROM). The storage 93 is, for example, a storage device such as a hard disk drive (HDD), a solid state drive (SSD), or a memory card. The storage 93 may be a memory such as the RAM or the ROM.

A program is stored in the storage 93. This program includes a command group (or software code) for causing the computer 90 to perform one or more functions in the monitoring devices 10,10A, and 10B described above in a case of read by the computer. The components in the monitoring devices 10,10A, and 10B described above may be implemented by the processor 91 reading and executing a program stored in the storage 93. The storage function in the monitoring devices 10,10A, and 10B described above may be realized by the memory 92 or the storage 93.

Further, the above-described program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The input/output interface 94 is connected to a display device 941, an input device 942, a sound output device 943, and the like. The display device 941 is a device that displays a screen associated with drawing data processed by the processor 91, such as a liquid crystal display (LCD), a cathode ray tube (CRT) display, or a monitor. The input device 942 is a device that receives operator's operation input, and is, for example, a keyboard, a mouse, a touch sensor, or the like. The display device 941 and the input device 942 may be integrated and implemented as a touch panel. The sound output device 943 is a device that acoustically outputs a sound associated with acoustic data processed by the processor 91, such as a speaker.

The communication interface 95 transmits and receives data to and from an external device. For example, the communication interface 95 communicates with an external device via a wired communication path or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Further, each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### Supplementary Note 1

A monitoring device including:
at least one memory that stores instructions; and
at least one processor configured to execute the instructions to:
   receive backscattered light from an optical fiber laid around a gas reservoir provided in a ground;
   identify a temporal change in vibration generated in the optical fiber based on the backscattered light, and identify a state of the gas reservoir based on the temporal change in the vibration; and
   control a gas injection amount into the gas reservoir based on the state of the gas reservoir.

### Supplementary Note 2

The monitoring device according to Supplementary Note 1, in which the at least one processor is further configured to identify the state of the gas reservoir based on a temporal change in the vibration generated in the optical fiber by transmitting a seismic wave generated in a seismic wave generation source and reflected by a stratum to the optical fiber.

### Supplementary Note 3

The monitoring device according to Supplementary Note 1, in which the at least one processor is further configured to:
learn in advance a feature of a noise component included in a first image obtained by imaging the temporal change of the vibration identified based on the backscattered light;
suppress the noise component from the first image based on a learning result; and
identify the state of the gas reservoir based on an image after the noise component is suppressed from the first image.

### Supplementary Note 4

The monitoring device according to Supplementary Note 3, in which the at least one processor is further configured to learn the feature of the noise component included in the first image based on a difference in resolution between a second image obtained by imaging a temporal change in the vibration identified using a predetermined method and the first image.

### Supplementary Note 5

The monitoring device according to Supplementary Note 4, in which the predetermined method is a method using a three-dimensional physical exploration vessel or an Ocean Bottom Cable (OBC).

### Supplementary Note 6

The monitoring device according to Supplementary Note 1, in which the gas reservoir is a reservoir for storing carbon dioxide as the gas.

### Supplementary Note 7

A monitoring method executed by a monitoring device, including:
receiving backscattered light from an optical fiber laid around a gas reservoir provided in a ground;
identifying a temporal change in vibration generated in the optical fiber based on the backscattered light, and identifying a state of the gas reservoir based on the temporal change in the vibration; and
controlling the gas injection amount into the gas reservoir based on the state of the gas reservoir.

### Supplementary Note 8

A program for causing a computer to execute:
receiving backscattered light from an optical fiber laid around a gas reservoir provided in a ground;
identifying a temporal change in the vibration generated in the optical fiber based on the backscattered light and identifying a state of the gas reservoir based on the temporal change in the vibration; and
controlling the gas injection amount into the gas reservoir based on the state of the gas reservoir.

Note that, some or all of elements (e.g., structures and functions) specified in Supplementary Notes 2 to 6 dependent on Supplementary Note 1 may also be dependent on Supplementary Notes 7 and 8 in dependency similar to that of Supplementary Notes 2 to 6 dependent on Supplementary Note 1. Some or all of elements specified in any of Supplementary Notes may be applied to various types of hardware, software, and recording means for recording software, systems, and methods.

What is claimed is:

1. A monitoring device comprising:
at least one memory that stores instructions; and
at least one processor configured to execute the instructions to:
receive backscattered light from an optical fiber laid around a gas reservoir provided in a ground;
identify a temporal change in vibration generated in the optical fiber based on the backscattered light, and identify a state of the gas reservoir based on the temporal change in the vibration; and
control a gas injection amount into the gas reservoir based on the state of the gas reservoir.

2. The monitoring device according to claim 1, wherein the at least one processor is further configured to identify the state of the gas reservoir based on a temporal change in the vibration generated in the optical fiber with a seismic wave generated in a seismic wave generation source and reflected by a stratum being transmitted to the optical fiber.

3. The monitoring device according to claim 1, wherein the at least one processor is further configured to:
learn in advance a feature of a noise component included in a first image obtained by imaging the temporal change in the vibration identified based on the backscattered light;
suppress the noise component from the first image based on a learning result; and
identify the state of the gas reservoir based on an image after the noise component is suppressed from the first image.

4. The monitoring device according to claim 3, wherein the at least one processor is further configured to learn the feature of the noise component included in the first image based on a difference in resolution between a second image obtained by imaging a temporal change in the vibration identified using a predetermined method and the first image.

5. The monitoring device according to claim 4, wherein the predetermined method is a method using a three-dimensional physical exploration vessel or an Ocean Bottom Cable (OBC).

6. The monitoring device according to claim 1, wherein the gas reservoir is a reservoir for storing carbon dioxide as the gas.

7. A monitoring method executed by a monitoring device, comprising:
receiving backscattered light from an optical fiber laid around a gas reservoir provided in a ground;
identifying a temporal change in vibration generated in the optical fiber based on the backscattered light, and identifying a state of the gas reservoir based on the temporal change in the vibration; and
controlling a gas injection amount into the gas reservoir based on the state of the gas reservoir.

8. A non-transitory computer readable medium storing a program for causing a computer to execute:
receiving backscattered light from an optical fiber laid around a gas reservoir provided in a ground;
identifying a temporal change in vibration generated in the optical fiber based on the backscattered light and identifying a state of the gas reservoir based on the temporal change in the vibration; and
controlling a gas injection amount into the gas reservoir based on the state of the gas reservoir.
